(19) United States
(12) Patent Application Publication
(10) Pub. No.: US 2011/0197385 A1
(43) Pub. Date: Aug. 18, 2011

(54) WIPER SYSTEM HAVING A WIPER DRIVE FOR DRIVING A WIPER LINKAGE

(75) Inventors: Guenter Bauer, Gaggenau (DE); Andreas Benner, Buehlertal (DE); Martin Steinmetz, Stuttgart (DE); Jan Dietrich, Buehl (DE); Achim Kraus, Buehl (DE)

(73) Assignee: ROBERT BOSCH GMBH, Stuttgart (DE)

(21) Appl. No.: 12/673,189

(22) PCT Filed: Jul. 3, 2008
(86) PCT No.: PCT/EP08/58569

§ 371 Date: Feb. 12, 2010

(30) Foreign Application Priority Data
Aug. 28, 2007 (DE) 10 2007 040 504.0

(51) Int. Cl. B60S 1/02

(52) U.S. Cl. 15/250.31

(57) ABSTRACT

In order to reduce the extent of assembly, the invention proposes a wiper system (1) having a wiper drive (3) for driving a wiper linkage (10, 11, 12), wherein the wiper system (1) is connected to the vehicle at three positions, wherein two positions are provided at both wiper bearings (20, 21) for the wiper linkage (10, 11, 12). According to the invention, a plug-in connection (25, 30) is provided on the wiper drive (3) for connecting the wiper system (1) to the vehicle at the third position such that an elongated plug-in element (25), protruding laterally from the wiper drive (3), is provided for supporting forces and torques toward the vehicle coming from the wiper system (1), which engages into a correspondingly configured plug receptacle (30) at the end that is held on the vehicle for the torque-supporting removable connection.

### BACKGROUND OF THE INVENTION

The present invention relates to a wiper system having a wiper drive for driving a wiper linkage, wherein the wiper system is connected to the vehicle at three points.

In a wiper system, undesirable movements and displacements caused by forces and torques of the wiper system occur during the operation. It is therefore necessary to securely fasten the wiper drive to the vehicle or to the vehicle body. It is known to screw the wiper drive to the vehicle at three points via a screw connection. However, like every screw connection, this has the disadvantage of a relatively high outlay on installation, in particular because of the sometimes poor accessibility and the confined space prevailing in the interior of the motor.

### SUMMARY OF THE INVENTION

By contrast, the wiper system according to the invention having a wiper drive for driving a wiper linkage has the advantage of a significantly reduced outlay on installation. It is particularly advantageous that a screw connection otherwise required at the wiper motor can be replaced by a simple plug-in connection. It is highly advantageous in this case that, nevertheless, the same advantages are provided as with the screw connection, specifically in particular that, in addition to forces, torques of the wiper system can also be transmitted to the vehicle or to the vehicle body. It is therefore ensured that the wiper system is optimally supported on the vehicle and therefore a movement of the wiper system relative to the vehicle is minimized.

It is advantageous to configure the end region of a plug-in element of the wiper drive in the form of a fork which, for the torque-supporting, releasable connection, is supported on a plug-in receptacle which is designed as a peg or pin element. A simple, torque-supporting, releasable and secure plug-in connection of the wiper drive with respect to the vehicle or with respect to the vehicle body is therefore provided.

It is alternatively advantageous to design the plug-in element of the wiper drive in the form of a tongue which, for the torque-supporting, releasable connection, engages in a plug-in receptacle which is designed as a casing or bushing. A simple, torque-supporting, releasable and secure plug-in connection of the wiper drive with respect to the vehicle or the vehicle body is therefore likewise provided.

A particularly secure connection of the wiper drive to the vehicle body can advantageously be obtained by the tongue being of corrugated design, and the casing or bushing having an inner wall which is likewise correspondingly of correspondingly corrugated design.

A plug-in element design which can be realized in a simple manner arises if the plug-in element emerges or protrudes laterally away from a housing part of the wiper drive.

It is advantageous if the housing part of the wiper drive is a plate-type housing part which is simply then, for example, screwed to the remaining housing of the wiper drive by means of the integrally formed plug-in element.

It is also advantageous to provide a plug-in element which emerges or protrudes laterally away from a transmission housing of a transmission for a wiper motor of the wiper drive.

### BRIEF DESCRIPTION OF THE DRAWINGS

Exemplary embodiments of the invention are explained in more detail in the description below and are further clarified with reference to the drawing, in which:

FIG. 1 shows a wiper system having a wiper linkage and wiper drive which is provided with a plug-in element according to the invention as per a first exemplary embodiment,

FIG. 2 shows a top view of the only wiper drive with the plug-in element according to FIG. 1,

FIG. 3 shows a top view of the only wiper drive which is provided with the plug-in element according to the invention as per a second exemplary embodiment, and

FIG. 4 shows a side view of the wiper drive according to FIG. 3.

### DETAILED DESCRIPTION

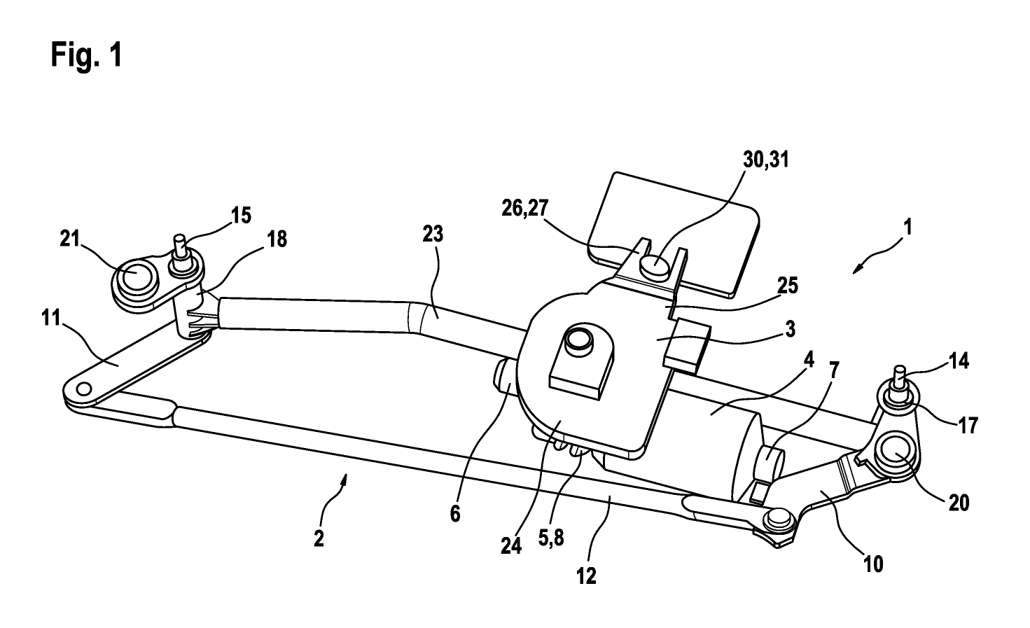

FIG. 1 shows a wiper system 1 for a vehicle. The wiper system 1 comprises a wiper linkage 2 which is driven via a wiper drive 3. For this purpose, the wiper drive 3 has a crank 6 which acts in an articulated manner on a first driving crank 10 via a driving rod 7. A second driving crank 11 is actuated via a connecting rod 12 which likewise acts in an articulated manner on the driving rod 7. The first driving crank 10 and second driving crank 11 are connected in a rotationally fixed manner to corresponding drive shafts, a first drive shaft 14 and a second drive shaft 15. The first drive shaft 14 is driven via the first driving crank 10 and the second drive shaft 15 is driven via the second driving crank 11. The drive shafts 14, 15 constitute the wiper shafts which are connected in a rotationally fixed manner to wiper arms of the vehicle. Wiper blades are fastened to free ends of the wiper arms. For the sake of better clarity, the wiper arms and wiper blades are not shown in FIG. 1.

The drive shafts 14, 15 are mounted rotatably in corresponding sleeve-shaped receiving means 17, 18 of wiper bearings 20, 21. The receiving means 17, 18 typically contain inserted bearing bushings. The first drive shaft 14 is mounted rotatably in a first receiving means 17 of a first wiper bearing 20, and the second drive shaft 15 is mounted rotatably in a second receiving means 18 of a second wiper bearing 21. The two wiper bearings 20, 21 are connected to each other via a supporting tube 23 which, for this purpose, acts, for example, on the receiving means 17, 18 which, in turn, are connected to the wiper bearings 20, 21. The wiper drive 3 as a driving unit, via the linkage 10, 11, 12, for the wiper blades or wiper arms is arranged approximately in the center of the supporting tube 23.

The wiper drive 3 comprises a cylindrical wiper motor 4 with an adjoining transmission 5 which is accommodated in a transmission housing 8. A bearing connecting piece (not illustrated), for example, for the mounting of an output shaft 9 (shown in more detail in FIG. 4) of the transmission 5 is provided on the transmission housing 8. FIG. 4 shows a side view of the wiper drive 3 in a direction according to an arrow 36 shown in FIG. 3. As FIG. 1 shows, the output shaft 9 is assigned the crank 6 which has, for example, a ball and socket joint via which the driving rod 7 is then actuated. In order to actuate the driving rod 7, the crank 6 is set by the drive shaft 9 into a reciprocating movement or into a revolving movement. The wiper drive 3 is customarily fastened at its transmission housing 8 to the supporting tube 23, thus providing a compact constructional unit or subassembly of wiper drive 3, supporting tube 23, wiper linkage 10, 11, 12 and wiper bearings 20, 21 with receiving means 17, 18 for the drive shafts 14, 15. In the case of the compact subassembly provided here, the wiper bearings 20, 21 and wiper drive 3 are connected fixedly to one another. In comparison to a “loose link” wiper system, in which the wiper bearings and the wiper drive or the wiper motor are not fixed with respect to one another, the compact wiper systems 1 have significant advantages with respect to tolerances and also vehicle manufacturing.

The transmission housing 8 and, if appropriate, sometimes the wiper motor 4, which contains an electric motor, are surrounded by a housing part 24 which contains the motor control electrics or motor control electronics and also other components on a plate and is therefore referred to below as the plate-type housing part 24.

The wiper bearings 20, 21 are preferably screwed by means of screws to the vehicle or to the vehicle body in the region of the motor interior at two points in the vicinity of the vehicle window. Undesirable movements or displacements occur because of the high forces and torques which emerge from the wiper drive 3 and from the wiper linkage 10, 11, 12 during the operation of the wiper system 1. It is therefore urgently necessary to securely fasten the wiper drive 3 to the vehicle or to the vehicle body, and, in addition to forces, in particular also torques which occur have to be transmitted to the vehicle or to the vehicle body. It is known for this purpose to screw the wiper drive to the vehicle via a screw connection. However, like every screw connection, this has the disadvantage of a relatively high outlay on installation, in particular because of the sometimes poor accessibility and the confined space prevailing in the interior of the motor. According to the invention, a reduction in outlay on installation while maintaining the same advantages of the screw connection is now proposed, specifically by the wiper drive 3 simply being plugged onto the vehicle or the vehicle body by means of an elongate plug-in element 25 at one point and subsequently being screwed at the two points to the wiper bearings 20, 21. Consequently, instead of the three screw connections hitherto necessary, only two screw connections should still be provided.

During the plugging-in operation, the end region 26 of the elongate plug-in element 25, which protrudes laterally away from the housing part 24 of the wiper drive 3, engages in a plug-in receptacle 30 of corresponding design on the vehicle. As FIG. 1 shows, the end region 26 of the plug-in element 25 can be in the shape of a fork 27. During the installation, the fork 27 is then connected releasably to the vehicle by the plug-in receptacle 30, if appropriate with slight elastic deformation. The plug-in receptacle 30 may be designed as a counterholder for the fork 27, for example as a peg or pin element 31. After the fork 27 is plugged onto the peg or pin element 31 and the wiper drive 3 fastened to the vehicle, the wiper system 1 can subsequently be screwed to its two wiper bearings 20, 21. An alternative connection of the wiper system 1 to the vehicle is therefore provided, said connection optimally supporting the forces and torques occurring in the wiper system 1 in the vehicle and minimizing a movement occurring of the wiper system 1 relative to the vehicle, in which case the outlay on the installation is considerably reduced. The plug-in element 25 has an elongate shape which, as indicated in FIG. 1, can also be designed such that it is bent over somewhat.

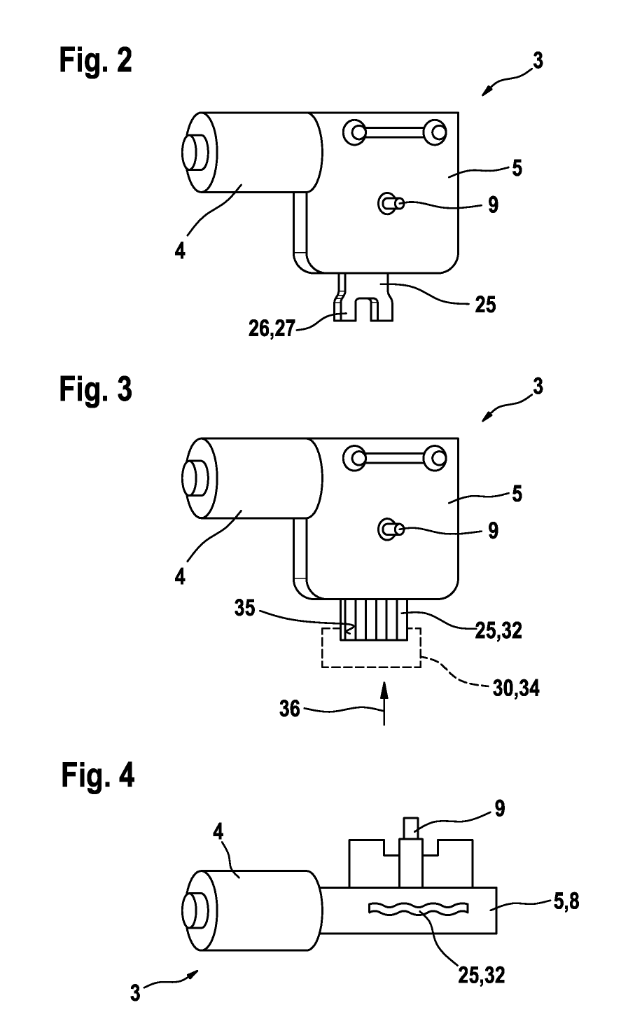

FIG. 2 shows a top view on its own of the wiper drive 3 without the wiper linkage and supporting tube, the end region 26 of the plug-in element 25 of said wiper drive likewise being in the shape of a fork 27. In contrast to FIG. 1, the plug-in element 25 according to FIG. 2 has, for example, a shape which is elongate and straight and is not bent over.

In FIG. 3, a top view on its own of the wiper drive 3 without the wiper linkage and supporting tube, shows a second exemplary embodiment according to the invention in which the elongate plug-in element 25 is designed in the form of a tongue 32. During installation, the tongue 32 is inserted into the correspondingly designed plug-in receptacle 30 which is held on the vehicle and is indicated in FIG. 3 by dashed lines. The plug-in receptacle 30 is designed, for example, in the form of a casing 34 of the bushing which surrounds the tongue 32 holding the latter at least partially in the fitted state. The tongue 32 can be produced from corrugated material, such as, for example, sheet metal. The tongue 32 may be integrally formed on the plate-type housing part 24 or, as illustrated in FIG. 4, may also be provided on the transmission housing 8 and may protrude laterally therefrom. In the case of a tongue 32 of corrugated design, the plug-in receptacle 25 then has an inner wall 35 which is likewise correspondingly of correspondingly corrugated design.

By means of the plug-in element 25 which is of elongate design and is guided away from the wiper drive 3 laterally from the housing 24, the wiper drive 3, in addition to being supported against forces which occur about the plug-in point, is also supported against torques which occur due to the lever effect of the plug-in element 25. In contrast to a rotationally symmetrical pin-type connection which cannot transmit any torques and can only transmit forces in the Y and Z directions, this constitutes a considerable advantage.

The plug-in element 25 can be provided from the transmission housing 8 and, for example, can be integrally formed thereon. It is also possible to attach the plug-in element 25 to the transmission housing 8, for example by screwing. As illustrated in FIG. 1, the plug-in element 25 may also be formed on the housing part or plate-type housing part 24, and, for example, may be integrally formed thereon.

The invention is not restricted to the described fork shape 27 or tongue shape 32 for the plug-in element 25. All types of plug-in connections which are of releasable design and are guided laterally away from the housing 24 of the wiper drive 3 and can be inserted into a receptacle or holder provided on the vehicle are conceivable.

The wiper system according to the invention is provided for driving window wipers in motor vehicles.

1. A wiper system having a wiper drive for driving a wiper linkage, wherein the wiper system is connected to a vehicle at three points, wherein two points are provided on two wiper bearings for the wiper linkage, characterized in that, in order to connect the wiper system (1) to the vehicle at a third point, a plug-in connection (25, 30) is provided on the wiper drive (3) in such a manner that, in order to support forces and torques emerging from the wiper system (1) with respect to the vehicle, an elongate plug-in element which protrudes laterally away from the wiper drive (3) is provided, said plug-in element (25) engaging on the end side in a plug-in receptacle (30), which is held on the vehicle and is of corresponding design, for the torque-supporting, releasable connection.

2. The wiper system as claimed in claim 1, characterized in that an end region (26) of the plug-in element (25) has the shape of a fork (27) which, for the torque-supporting, releasable connection, is supported on a plug-in receptacle (30) which is designed as a peg or pin element (31).

3. The wiper system as claimed in claim 1, characterized in that the plug-in element (25) is designed in the form of a tongue (32) which, for the torque-supporting, releasable connection, engages in a plug-in receptacle (30) which is designed as a casing or bushing (34).

4. The wiper system as claimed in claim 3, characterized in that the tongue (32) is of corrugated design, and the casing or bushing (34) has an inner wall (35) which is correspondingly of correspondingly corrugated design.

5. The wiper system as claimed in claim 1, characterized in that the plug-in element (25) emerges or protrudes laterally away from a housing part (24) of the wiper drive (3).

6. The wiper system as claimed in claim 5, characterized in that the housing part (24) of the wiper drive (3) is a plate-type housing part (24).

7. The wiper system as claimed in claim 1, characterized in that the wiper drive (3) comprises a wiper motor (4) and a transmission (5), the plug-in element (25) emerging or protruding laterally away from a transmission housing (8).

8. The wiper system as claimed in claim 4, characterized in that the plug-in element (25) emerges or protrudes laterally away from a housing part (24) of the wiper drive (3).

9. The wiper system as claimed in claim 8, characterized in that the housing part (24) of the wiper drive (3) is a plate-type housing part (24).

10. The wiper system as claimed in claim 4, characterized in that the wiper drive (3) comprises a wiper motor (4) and a transmission (5), the plug-in element (25) emerging or protruding laterally away from a transmission housing (8).
